(19) United States
(12) Patent Application Publication
(10) Pub. No.: US 2022/0225596 A1
(43) Pub. Date: Jul. 21, 2022

(54) ARTIFICIAL MANGROVE

(71) Applicant: NJB Limited, LLC, Durham, NC (US)

(72) Inventor: Nathaniel A. Urshan, II, Durham, NC (US)

(73) Assignee: NJB Limited, LLC, Durham, NC (US)

(21) Appl. No.: 17/154,230

(22) Filed: Jan. 21, 2021

(51) Int. Cl. A01K 61/73; A01K 61/78

(52) U.S. Cl. CPC A01K 61/73; A01K 61/78

(57) ABSTRACT

An improved artificial mangrove assembly designed to duplicate a natural mangrove that provides protection and promotes an underwater ecosystem, which can help reverse the decline in the fish population, aviary habitats, erosion, and the like and help to promote land and marine colonization.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to an underwater ecosystem. In particular, it relates to an artificial mangrove assembly that provides protection for smaller fish as well as other flora and fauna.

### Description of Related Art

The mangrove is a type of naturally occurring coastal ecosystem where trees grow in saline coastal sediment. Mangroves are usually found in the subtropics and in the tropics. Because the roots are positioned in the water, the roots form a habitat for marine life of all sizes. In addition, they trap nutrients and promote marine life colonization. However, these natural mangroves are disappearing for a number of reasons including logging, urban development, and tourism. The decreasing number of mangrove ecosystems contributes to many ocean problems including a decline in the fish population, threats to birds and their habitats, erosion, and the like.

Current artificial structures are inadequate for providing the complete sanctuary of all marine life, especially small and microscopic marine organisms. Examples of current artificial structures include dock pilings and sea walls. More recently an artificial “mangrove assembly” was developed, but the assembly provides only a limited amount of shelter space for marine life. It has a very large diameter and roots are positioned at a 90 degree angle to the attachment point. In addition, it provides little to no protection for smaller aquatic life and does not provide sufficient surface area for colonization. There is a need for an artificial mangrove that overcomes the problems of previous structures.

### BRIEF SUMMARY OF THE INVENTION

The present invention relates to an artificial mangrove, wherein the final roots are angled to an upright root at an angle from 0 to about 70 degrees. In addition, the roots are no more than 1 inch in diameter. This construction is an improvement over previous artificial mangroves in that it provides shelter for even the smallest aquatic creatures of the coast, it's easier to assemble, and less costly to build than previous artificial systems.

Accordingly, in one embodiment, there is an artificial mangrove designed for placement in a body of water comprising:
a) an attachment device for attachment of the artificial mangrove to a fixed surface;
b) a one or more horizontal connection members attached to the attachment device;
c) one or more vertical connection roots connected to each of the horizontal connection members; and
d) a plurality of angled connection roots connected to the vertical connection roots at an angle from 0 to about 70 degrees.

### BRIEF DESCRIPTION OF THE DRAWINGS

FIG. 1 is an embodiment of the present invention showing a particular anchoring of the artificial mangrove.

FIG. 2 is a side view of the present invention showing an alternative embodiment to anchor the artificial mangrove.

FIG. 3 is a perspective view of an embodiment of the present invention wherein the vertical connection roots are the dock pilings.

### DETAILED DESCRIPTION OF THE INVENTION

Mile this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “artificial mangrove” refers to an artificial construction that attempts to mimic a natural mangrove. Construction materials include marine grade plastic, rubber, and the like. Their use would be to duplicate the shelter that natural mangroves provide as much as is possible. In one embodiment, it means that there are roots going in various directions of a given material and having a diameter that closely resembles the structure of a natural mangrove.

As used herein, the term “attachment device” refers to a mechanism for attaching the artificial mangrove to a fixed surface on the shore of the body of water that the artificial mangrove is being used in. In some embodiments, it could be a pier, a retaining wall, a structure on the shore, or the like. The attachment could be screws, bolts, chains, adhesives, clamps, and the like, as needed for the structure being attached.

As used herein, the term “fixed surface” refers to a structure or the like, that the artificial mangrove can be securely attached to as described above.

As used herein, the term “horizontal connection member” refers to horizontal members being connected to the attachment device horizontally in relationship to the ground, in such a manner that the artificial mangrove will not come loose. This can be done in any convenient way including melt bonding, adhesives, straps, ropes, and the like. The vertical connection roots will be attached to the horizontal connection member. Materials for making the horizontal connection member include, but are not limited to, marine grade plastic and rubber. In one embodiment, they are made from the same material as the vertical and angled connection roots.

As used herein, the term “vertical connection roots” refers to roots that are connected vertically, i.e., essentially at 90 degrees to the horizontal connection member. They can extend all the way to the bottom of the body of water or any distance less than that. Materials for making the vertical connection roots include, but are not limited to, marine grade plastic and rubber.

As used herein, the term “angled connection roots” refers to roots that are connected to the vertical connection roots at an angle from 0 to about 70 degrees from below where the angled connection roots are attached to the vertical connection roots. An embodiment can be seen in the figures. They do not extend to the bottom of the body of water; rather they hang from the vertical connection roots with their distal end not connected to anything. Materials for making the angled connection roots include, but are not limited to, marine grade plastic and rubber. All roots will have a diameter of about 1 inch or less.

As used herein, the term “frame” refers to a structure which holds the artificial mangrove in place. It includes a bottom brace, one or more vertical braces, and could also include the horizontal connection member.

As used herein, the term “anchor” refers to a device system, or the like, which attaches the artificial mangrove to the bottom of the body of water. In includes, but is not limited to, anchors, weights, devices like stakes driven into the body of water bottom, and the like.

As used herein, the term “body of water” refers to any body of water where a natural mangrove could possibly exist on the shore of that body of water. Examples include seas, oceans, lakes, rivers, gulfs, bays, and the like.

### DRAWINGS

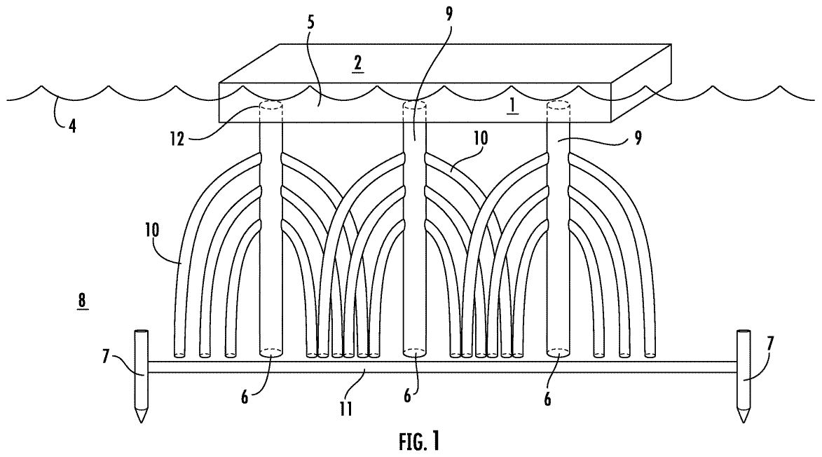

Now referring to the drawings, FIG. 1 is an embodiment of the present invention showing a particular anchoring of the artificial mangrove. In this embodiment, a horizontal connection member 1 is connected to fixed surface 2. The horizontal connection member 1 can be positioned above or below the surface of a body of water 4. A frame 5 consists of the horizontal connection member 1 and vertical uprights 6. The frame 5 is held in place by anchors 7 on the bottom of the body of water 8.

Attached vertically to the horizontal connection member 1 are vertical connection roots 9. Attached to the vertical connection roots 9 are angled connection roots 10. The angled connection roots 10 are positioned at an angle of about 45 degrees relative to the vertical connection roots 9 below the connection 12 of the vertical and angled connection roots. In other embodiments, the angle of the angled connection roots 10 is between 0 and about 70 degrees or draped in an arc, as shown. In this embodiment, there is a bottom cross frame piece 11 with the frame.

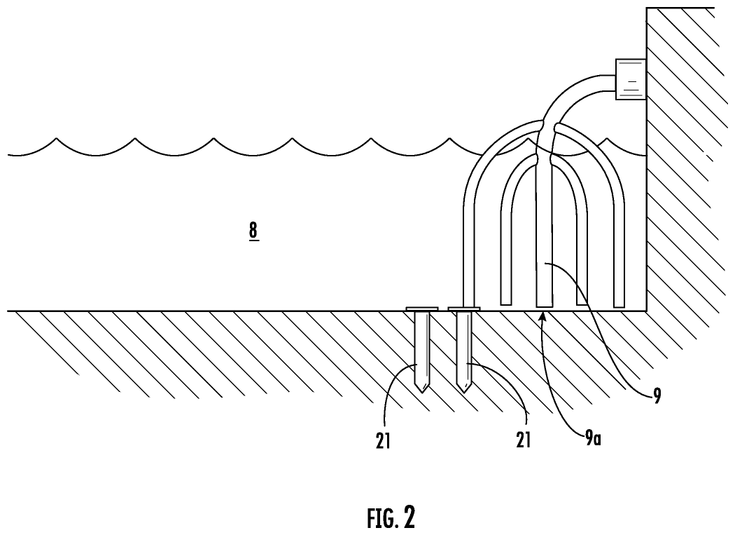

FIG. 2 is a side view of the present invention showing an alternative embodiment to anchor the artificial mangrove. In this view, the vertical connection roots 9 can be extended 9a to the bottom of the body of water 8. This embodiment also has stakes 21 holding the frame in place in the water.

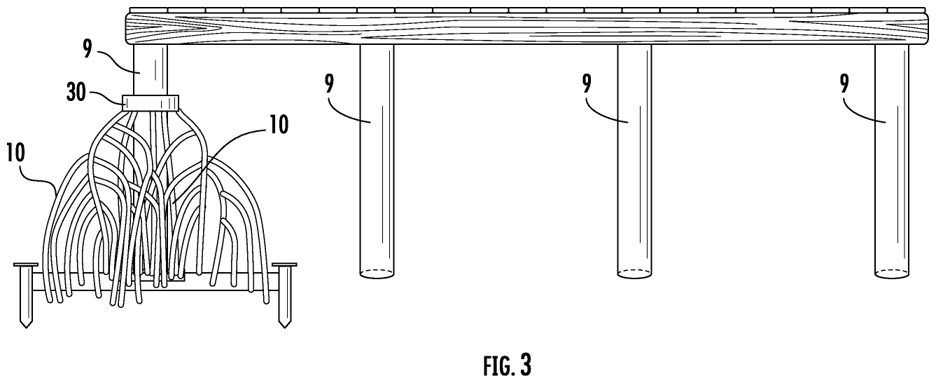

FIG. 3 is a perspective view of an embodiment of the present invention wherein the vertical connection roots 9 are the dock pilings. The angled connection roots 10 are attached by piling coupling device 30. As shown in this view, the angle of the angled connection roots 10 varies from 0 to about 70 degrees relative to the vertical connection roots 9.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A positionally fixed artificial mangrove designed for placement in a body of water comprising:
a) a piling having a shore side and a body of water side;
b) a piling coupling for fixed attachment of the artificial mangrove to the piling;
c) one or more vertical connection roots connected to the piling coupling only on the body of water side of the piling;
d) a plurality of angled connection roots connected to the vertical connection roots only on the body of water side of the piling at an angle from 0 to about 70 degrees; and
e) one or more positionally fixed anchors, which attach a plurality of the artificial mangrove connection roots to a horizontal bottom of the body of water.

2. The positionally fixed artificial mangrove designed for placement in a body of water according to claim 1 wherein the vertical connection roots and the angled connection roots are made from one or more of the group consisting of marine grade plastic and rubber.

3. The positionally fixed artificial mangrove designed for placement in a body of water according to claim 1 wherein the angled connection roots have a diameter of about 1 inch or less.

4. The positionally fixed artificial mangrove designed for placement in a body of water according to claim 1 wherein the artificial mangrove is positioned in the body of water.

5. (canceled)

6. (canceled)

7. The positionally fixed artificial mangrove designed for placement in a body of water according to claim 1, wherein the anchor is one or more stakes which are driven into the horizontal bottom of the body of water.
